(19) United States
(12) Patent Application Publication
(10) Pub. No.: US 2012/0175532 A1
(43) Pub. Date: Jul. 12, 2012

(54) COMPACT MODULAR EBEAM SYSTEMS AND METHODS

(75) Inventors: Mark W. Victor, Murrieta, CA (US); David E. Cooper, Glendora, CA (US); Maria C. Samayoa, Inglewood, CA (US); Terry Lee Kover, Anaheim, CA (US); Max Dell Miller, JR., Manhattan Beach, CA (US); Martin Brown, Riverside, CA (US); Thomas R. Duran, JR., Downey, CA (US)

(73) Assignee: USHIO AMERICA, INC., Cerritos, CA (US)

(21) Appl. No.: 13/150,514

(22) Filed: Jun. 1, 2011

Related U.S. Application Data
(60) Provisional application No. 61/431,628, filed on Jan. 11, 2011.

(51) Int. Cl. G21K 5/00; H01J 33/04

(52) U.S. Cl. 250/492.3; 313/420

(57) ABSTRACT

In an Ebeam system, the cathode assembly and/or the window assembly can be simply and quickly replaced or exchanged as required by conditions of use, without replacing the vacuum chamber, or other component systems. In some cases, replacement may be made without removing the vacuum chamber from its installed position. As a result, the cathode assembly and the window assembly can be readily changed over for maintenance. In addition, modular replacement cathode assemblies and window assemblies having varying characteristics may be selected to match a specific desired application, and then installed into the system. The system may be designed as a compact and lightweight portable device.

### PRIORITY CLAIM

This application claims priority to U.S. Provisional Patent Application No. 61/431,628 filed Jan. 11, 2011, incorporated herein by reference.

### FIELD OF THE INVENTION

The present invention relates to Electron Beam (Ebeam) apparatus and methods.

### BACKGROUND

Ebeam systems are used to cure or cross-link polymers in manufacturing electrical insulation on wire and cable, heat-shrink tubing, paints or other surface coatings, tires, etc. In a typical curing application, the target material is exposed to the electron beam radiation which initiates free radical or cationic polymerization. The Ebeam radiation may also volatize the material. With Ebeam curing, no chemical initiators are needed in the coating, and the curing is also unaffected by opacity, color or pigmentation of the material. Release of pollution causing volatile organic compounds or hazardous vapors can also be better reduced with Ebeam curing. Ebeam systems can also be used to sterilize medical equipment and products, process food items, and to harden or cure various types of coatings, liquid resins, composites and other materials.

An Ebeam system typically includes a DC high voltage power supply connected to an electron gun within an accelerating tube. A vacuum is provided in the tube to avoid beam scattering by air molecules. The Ebeam generated by the electron gun passes out of the accelerating tube through an irradiation window. The window is sealed with a thin foil to maintain the vacuum in the accelerating tube, with the Ebeam passing through the foil.

The electron gun generally has one or more filaments which burn out over time. This requires that the system be dismantled at least in part, to access and repair the electron gun. The foil window is subject to constant pressure forces resulting from the ambient pressure on one side of the foil and the vacuum on the other side. The foil window also absorbs a certain fraction of the Ebeam. This heats the foil resulting in thermal stress. The pressure and thermal stresses fatigue the foil. As a result, the foil must be replaced periodically, for example every few months.

Historically Ebeam sources have been built as self enclosed systems having a single fixed window and a fixed output power. These characteristics limit their flexibility. These Ebeam systems are also typically large and bulky systems that are not user friendly. Indeed, because they are not easily moved, typical Ebeam systems are generally mounted in place, which limits their uses.

Another problem with existing Ebeam systems is that they can be difficult to maintain. Not only are these systems complex, they are designed in ways that can make access to internal components difficult. Consequently, existing Ebeam systems generally require significant time and effort to maintain. For example, failures often require that the system be returned to the manufacturer for repair, or that specially trained maintenance persons be deployed to do on-site repairs. Accordingly, improved Ebeam systems and methods are needed.

### SUMMARY

In one aspect, the electron source of the Ebeam system, such as a cathode assembly, may be relatively quickly and easily replaced or exchanged, without disassembly of the entire system, and without the need for any special tools or training. The cathode assembly may be provided as a replaceable module Replacement may then advantageously be made by the user on site, without returning the system to the manufacturer for service, and without the need for any manufacturer's service representative at the user's site. In a second aspect, the window of the Ebeam system may similarly be provided as an easily replaceable module.

With the cathode assembly and/or the window designed as a substantially self-contained module, it can be removed and replaced with a new module with minimum tools, time and skill. This allows the user to replace these components as may be needed due to wear and aging. In addition, apart from just maintaining the system, the system may be easily upgraded or modified by changing over a cathode assembly module and/or a window module. For example, by installing a selected cathode assembly module and/or a selected window module, the output energy and power of the system can be varied to match a variety of scientific and industrial applications. In another separate aspect, Ebeam systems including these features may be provided as a compact and portable apparatus

Other objects and advantages will become apparent from the following detailed description. The invention resides as well in sub-combinations of the features and method steps described.

### BRIEF DESCRIPTION OF THE DRAWINGS

FIG. 1 is an exploded perspective view showing one example of the Ebeam system of the invention.

FIG. 2 is a schematic side view of the system of FIG. 1 set up to cure a moving web of material.

FIG. 3 is top view of the system shown in FIG. 2.

### DETAILED DESCRIPTION

### 1. Overview.

An Ebeam system includes a cathode assembly or other electron source, within a tube having a window assembly. An electrical power source is connected to the cathode assembly. The cathode assembly and the window assembly are provided as modules. They are attached to the tube in a way that allows them to be easily removed for service, replacement, or changeover. For example, the modules are attached to the tube via bolts that easily accessible. Removing the bolts then allows the cathode assembly, or the window assembly, to be removed as a whole module or unit, and replaced with a new unit. The need for making in-situ repairs is eliminated as the worn or damaged cathode assembly module or window assembly module is simply replaced with a new factory-supplied module. The worm or damaged modules may be returned to the factory for refurbishment. The modules may be optionally be provided as a kit, with the user selecting specific modules from the kit for use in specific applications.

The present Ebeam system typically operates with a vacuum inside the sealed tube. Where a window assembly is provided on the tube to maintain a vacuum seal, the exposure area irradiated by the electron beam can have any desired atmosphere. Alternatively the system can be operated without any window, with the exposure chamber and the tube both maintained under vacuum conditions.

The system may be provided with multiple window assemblies, each including a different window foil permanently pre-attached to a central grid or lattice structure of a window flange. This provides a modular design and allows the user to switch between windows as desired to better match the size and shape of the window, and the material and thickness of the window foil (and supporting grid).

### 2. Window Modules.

A method of making an electron permeable window is provided in U.S. Pat. No. 4,494,036 incorporated herein by reference. The window assembly module can be connected to the sealable tube in a variety of ways, e.g., using any suitable connecting mechanism, such as, for example, a flange system such as KF or CF design, with or without the use of knife edges, metallic gasket(s) or O-rings.

The window foil is made of a material suitable for electron transmission. These materials are generally materials with low electron density in the body of the material, to allow electrons to easily pass through. These include metals such as aluminum, titanium, silicon, tantalum, havar alloy and the like. Non-metals such as carbon, graphite, diamond, diamond-like carbon, and the like may also be used. Organic polymers including Mylar polyester and Vespel or Kapton polyimide, and inorganic materials such as mica, boron nitride, silicon carbide, alumina, garnet, sapphire, ruby, magnesium fluoride, calcium fluoride, synthetic fused silica, silicon dioxide, doped synthetic fused silica, and the like, as well as metalized versions of these materials, may also be used. Another class of materials that may be used is conducting polymers such as polythiophene, polyaniline, polyacetylene, and the like, as well as substituted analogues thereof. To reduce energy losses, thin layer semiconductor materials may also be used. Polyether ether ketone (PEEK) may also be advantageously used.

Depending on the material used, the thickness of the window foil may vary to produce optimal electron transparency. Generally the window foil thickness ranges from about 0.05 microns to about 20 microns or about 0.5 to about 10 microns can be used. Typically, the thickness of the window foil material is in the range of about 2-8 microns, depending on the density of the material to the electron transmission. Materials in these ranges may appear as translucent or completely opaque

The window foil or film material is typically mounted onto a window flange using standard foil or film mounting technologies. The window flange is designed to allow electron transmission and to support the window film, and it may have various geometric shapes. For example, the window can be round, square, rectangular, triangular, slotted, bifurcated slots, etc. The window geometry is determined based on the film thickness, desired electron pattern and the desired open area of the window. A central grid or lattice structure may be attached to the window flange, for supporting the window film.

### 3. Electron Source.

The electron source may be field emission, thermionic, plasma, nanotube, or a similar type of source. The thermionic system typically has a cathode assembly as the electron source. Thermionic emission sources include tungsten and tantalum wires and alloys of these materials. The emission source is typically connected to a high voltage DC power supply. The emission source, which is sealed inside of the tube and the high voltage supply, can be electrically connected through a flange using e.g., KF and CF flange designs. High voltage feed through devices include spark plugs or other ceramic (such as alumina) or plastic (such as PEEK) devices.

The output energy of the present Ebeam systems may range from about 0.1 up to about 500,000 electron volts, with ranges of 1.0 to about 150,000 electron volts or 25,000 to about 75,000 electron volts typically used. For portable versions of the invention, output energies may generally be less than 50,000 electron volts, to reduce the amount of x-rays generated and/or the amount of shielding necessary.

### 4. Vacuum.

The vacuum system can have one or more stages and can include a roughing pump and a high vacuum pump. Exemplary types of high vacuum pumps include a diffusion pump, a turbo-molecular pump, an ion gauge pump, a cryogenic vacuum pump or a combination of vacuum pumps that will maintain the vacuum in the system below the glow discharge pressure. The vacuum pump(s) may be connected to the tube via connectors such as KF and CF flanges, hose nipples, and the like. The resulting connections can be bolted or externally clamped. A simple way to attach the system to the vacuum pump is using a flange (either KF or CF) and attaching the flange via screws or bolts to an identical flange on the pump system. This allows for alignment of the flange and maintaining a seal even at high vacuum levels.

### 5. System Controller.

A system controller may be used to control the applied voltage and current to the electron source. The controller may be a touch screen controller or a computer controller. For the touch screen control system an off the shelf system from EZ Automation (Bettendorf, Iowa, USA) can be used. For the computer controlled system an off the shelf program such as Labview (National Instruments, Austin, Tex., USA) can be used and customized to operate the Ebeam system. The computer control can combine the ability to control the output with feedback information about the performance of the system not available with the free standing control system.

### 6. Design Examples.

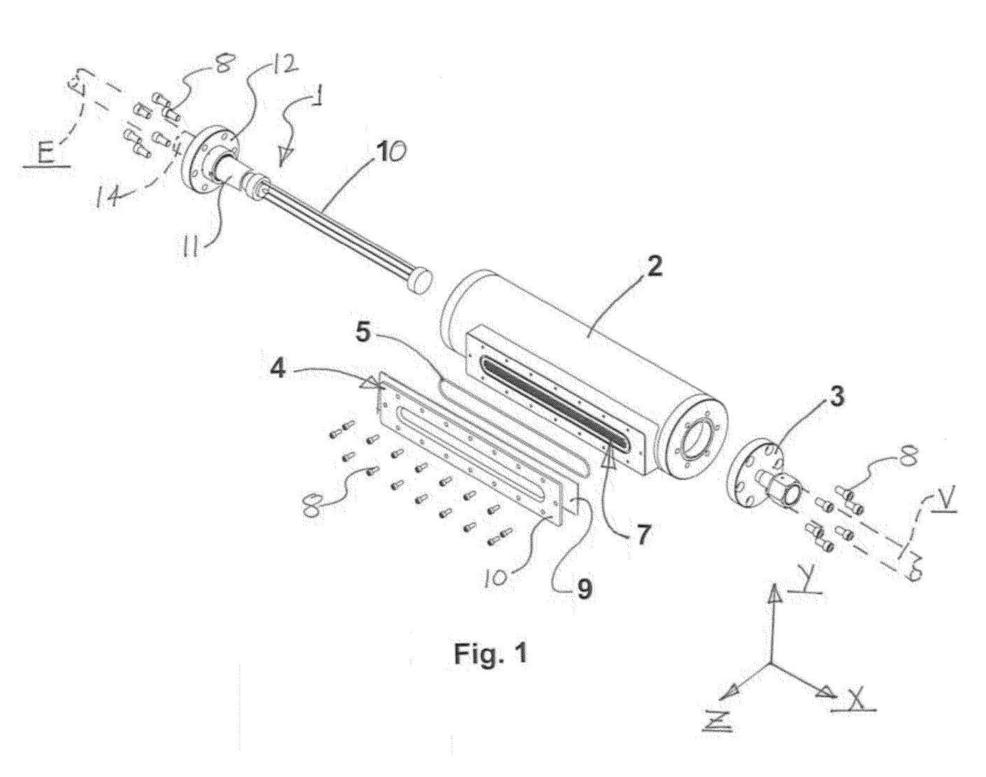

Turning now in detail to the drawings, as shown In FIG. 1, a window flange 4 is bolted onto a tube 2, with an o-ring or similar seal element 5 between them. The flange 4 and the seal element 5 create a substantially vacuum tight seal of the window material 9 on the tube 2. The sealable tube 2 has an end vacuum flange 3 connected to a vacuum line V at one end of the tube 2. The vacuum line V is connected to a vacuum pump. A filament assembly 1 is electrically connected to a joined to a high voltage feed through bolted or otherwise attached at the other end of the sealable tube 2. A cable E is connected to a high voltage DC power supply and to a connector attached to the feed through. In use, the filament assembly 1 emits electrons. An extraction grid associated with the filament assembly may be used to focus or direct the electrons towards the window opening. No external focusing coil outside of the tube is needed.

The length of the tube 2 is usually less than about 36 inches, with a preferred length of about 6-24 inches or about 8-12 inches. The diameter of the tube may vary from about 1 up to about 24 inches, with typical diameters ranging from about 2-12 inches or 4-8 inches. One or more window assemblies are located along the long axis of the tube.

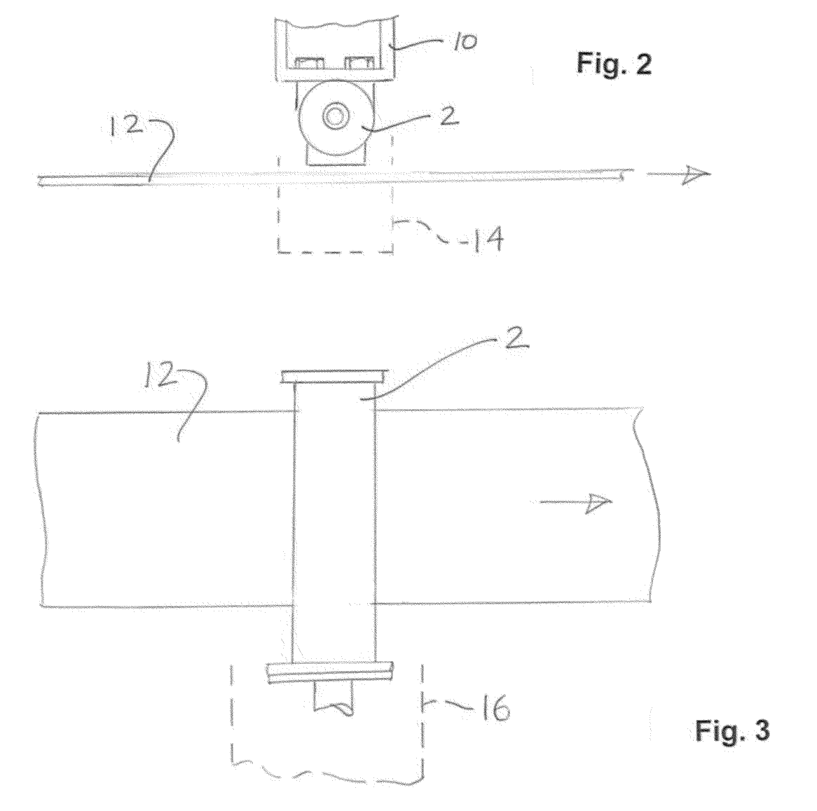

As shown in FIGS. 2 and 3, the tube 2 may be supported on a fixture 10 suspended adjacent to a moving web 12 of material, such a painted or coated surface, or a composite matrix material. In this application, the Ebeam may be used to cure the material.

Referring to FIGS. 1-3, for this purpose, the tube 2 may have a relatively long and narrow window opening 7, substantially matching the width of the web of material. For example, the tube 2 may have a 3 or 4 inch diameter and a length of 8-12 inches, with a window opening 7 having a length of about 6-10 inches, or about 1-3 or 4 inches less than the length of the tube 2. The width of the window opening 7 may correspondingly be about 0.2 to about 1.5 or 2.0 inches, depending size of the tube 2. The size and shape of the window opening 7 may be selected based on the width of the web of material 12.

Referring to FIG. 1, the filament or cathode assembly 1 can be provided as an easily replaceable module. When provided as a module, the cathode assembly 1 includes one or more filaments 10 attached to a base feedthrough 11 supported within a mounting flange 12. An electrical connector 14 on the outside of the flange allows the power cable E to be quickly and easily removed during replacement of the cathode assembly 1. With the cathode assembly 1 attached to the tube 2 using cap screws or similar fasteners 8, it can be replaced simply by removing the screws 8 and one or more electrical connectors. Referring to FIGS. 1-3, the screws 8 are exposed and are easily accessible, allowing the cathode assembly 1 to be replaced in situ, without the need to move or dismantle the Ebeam system.

As shown in FIG. 1, the window assembly 4 may also be provided as an easily replaceable window module, including the window flange or frame 10 and the foil or other window barrier material 9 pre-attached to the window frame 10. The window assembly is attached to the tube 2 using screws 8 and can similarly be replaced simply by removing the screws 8. Referring to FIGS. 1-3, the screws 8 attaching the window assembly 4 to the tube 2 are easily accessible, allowing it to be quickly and easily replaced. Since the replacement window assembly includes the foil 9, there is no need for the user to separately replace the foil.

In FIG. 2, the web of material 12 may be temporarily removed or displaced, to allow access to the screws 8 holding the window assembly 4 in place, if necessary. The fixture 10 may be temporarily released or loosened as needed, to allow the tube 2 to rotate e.g., up to 90 degrees, or to shift laterally. In the system, an open access space 14 may be provided around the window assembly 4, with no other system components or other objects obstructing access to the screws 8. As shown in FIG. 2, with the web of material 12 removed or displaced to one side, the window open access space 14 provides a volume of space around the window.

For example, referring to FIGS. 1-3, the window access space 14 may be a rectangular prism of open or empty space centered over the window assembly and extending e.g., 0.5 to about 2 inches beyond the window assembly 4 in the X and Y directions, and extending out from the window assembly by about 4-12 inches, to allow easy access to the screws 8. A similar cathode open access space 16 may be provided for the cathode assembly 1. In this case, the cathode open access space may be cylindrical with a diameter 1-3 inches greater than the diameter of the cathode assembly flange and 1-6 inches longer than the length of the cathode assembly.

The window open access space may be a three dimensional rectangular prism of open space extending outwardly in a direction perpendicular to the window foil by at least 25 cm. Similarly, the cathode assembly open access space may be a three dimensional cylindrical prism of open space extending outwardly from the outer section of the cathode assembly by a dimension greater than the length of the inner section of the cathode assembly, to allow the inner section of the cathode assembly to be withdrawn and removed from the tube, without removing substantially any other system components.

The Ebeam system in FIG. 1 may be adapted as low energy, light weight and compact systems. In this adaptation, the system is portable, and thus easy to use in a variety of locations and applications. The compact dimensions of the tube also allow the tube to be positioned in a wide variety of positions and locations. The portable system advantageously weighs less than 100 pounds. Of course, the principles of the invention as described here may also be used in larger, heavier and essentially non-portable designs as well

Thus, novel systems and methods have been shown and described. Various changes and substitutions may of course be made without departing from the spirit and scope of the invention. The invention, therefore, should not be limited, except to the following claims and their equivalents.

What is claimed is:

1. An Ebeam system, comprising:
a sealed elongated tube having a window opening;
a cathode assembly having at least one filament attached to a feedthrough base supported by a flange, with the filament inside of the tube, and with the flange attached to an outer surface of the tube via a first set of exposed fasteners;
an electrical connector attached to the flange; and
a window assembly including a window foil supported on a window mesh attached to a window flange, with the window flange attached to the tube over the window opening via a second set of exposed fasteners.

2. The system of claim 1 with the tube having a length of 4-12 inches and the window opening has a length of 3-11 inches, and a width of 0.2 to 2 inches.

3. The system of claim 1 further comprising a power supply remote from the tube and electrically connected to the cathode assembly via a cable attached to the connector on the flange of the cathode assembly.

4. The system of claim 3 further comprising a vacuum source remote from the tube and connected to the interior of the tube via a vacuum line attached to a vacuum fitting on the tube.

5. An Ebeam system comprising:
a sealed elongated tube having a window opening;
a cathode assembly having inner and outer sections, with the inner section of the cathode assembly inside of the tube, and with the outer section of the cathode assembly attached to an outer surface of the tube via a first set of exposed fasteners; and
a window assembly including a window foil supported on a window mesh attached to a window flange, with the window flange attached to the tube over the window opening via a second set of exposed fasteners;
a fixture supporting the tube adjacent to a movable web of material, with the window opening facing the web of material and with the window opening having a length substantially equivalent to the width of the web of the material;
a power supply remote from the tube and electrically connected to the cathode assembly via a cable leading to a feed through on the tube; and
a vacuum source remote from the tube and connected to the interior of the tube via a vacuum line attached to a vacuum fitting on the tube.

6. The system of claim 5 further comprising a cathode assembly open access space adjacent to the cathode assembly and a window assembly open access space adjacent to the window assembly, to allow the cathode assembly and the window assembly to be removed and replaced, respectively, without removing any other system component.

7. A method for treating material using an Ebeam system, comprising:
attaching a cathode assembly to an end of a sealed elongated tube via a first set of exposed fasteners;
attaching a window assembly having a window foil onto the tube over an elongated window opening in a sidewall of the tube via a second set of exposed fasteners;
attaching the sealed tube to a support fixture, with the window opening facing the material to be treated;
creating a partial vacuum within the tube;
applying electric current to the cathode assembly, with the cathode assembly projecting an Ebeam through the window assembly and onto the material to be treated; and
when the window foil becomes damaged:
replacing the window assembly by removing the second set of exposed fasteners, removing the window assembly, installing a new window assembly, and replacing the second set of fasteners, and without removing any other component of the system.

8. The method of claim 7 further comprising replacing the cathode assembly when the cathode assembly is no longer operable by removing the first set of exposed fasteners, removing the cathode assembly from the tube; replacing the cathode assembly with a new cathode assembly, replacing the first set of exposed fasteners, and without removing any other component of the system during the cathode replacement steps.
